(19) United States
(12) Patent Application Publication
(10) Pub. No.: US 2026/0330808 A1
(43) Pub. Date: Oct. 22, 2026

(54) METHOD FOR EXTRACTING FEATURES FROM SENSOR DATA

(71) Applicant: Robert Bosch GmbH, Stuttgart (DE)

(72) Inventors: Annika Hagemann, Hildesheim (DE); Jan Fabian Schmid, Hamburg (DE)

(21) Appl. No.: 19/568,291

(22) Filed: Mar. 16, 2026

(30) Foreign Application Priority Data
Mar. 18, 2025 (DE) 10 2025 110 336.4

(51) Int. Cl. G06V 10/77; G06T 5/20; G06T 5/73; G06T 7/246; G06T 7/73; G06V 10/74

(52) U.S. Cl. CPC G06V 10/7715; G06T 5/20; G06T 5/73; G06T 7/246; G06T 7/73; G06V 10/761

(57) ABSTRACT

The invention relates to a computer-implemented method for extracting features from sensor data using a machine learning system for extracting features, characterized in that the machine learning system for extracting features performs feature extraction based on multiple deconvolutions of the sensor data, the method comprising:
performing a deconvolution of the sensor data into tensors, wherein a plurality of tensors of different dimensions is created in parallel processing for at least one measurement point of the sensor data in order to obtain multiple sensor data tensors;
performing at least one preprocessing convolution on each sensor data tensor to obtain preprocessing tensors;
performing reconvolution of each preprocessing tensor back to the original dimension of the sensor data to obtain reconvolution sensor data;
component-wise summation of the reconvolution sensor data from parallel processing to obtain a joint representation;
applying a localization head to the joint representation to obtain a localization tensor;
deriving a feature position tensor for extracted features based on the localization tensor. Furthermore, the invention relates to a device and a computer program.

### FIELD

The present disclosure relates to a computer-implemented method for extracting features from sensor data. Furthermore, the present disclosure relates to a device and a computer program.

### BACKGROUND INFORMATION

Extracting features from sensor data, such as image data, is a key component in the environmental perception of robots, in particular of autonomous vehicles. By extracting features, matching features, for example, can be found in multiple measurement points of sensor data, which in turn allows tracking of the features across the measurement points and thus an estimation of the sensor's movement in the environment.

One approach to feature extraction is offered by the XFeat architecture (arxiv.org/abs/2404.19174). XFeat offers a high-performance architecture, but has weaknesses in feature localization. Thus, the receptive field in XFeat is constant, which necessitates a compromise in perceiving small, detailed features compared to larger or repetitive features. Furthermore, XFeat does not facilitate feature localization with floating-point precision, which is important in particular for further processing steps.

This creates a need for a method for extracting features from sensor data that can perceive both detailed features and large or repetitive features and is thereby highly scalable.

### SUMMARY

The method according to the present disclosure for extracting features from sensor data using a machine learning system for extracting features has an advantage that the machine learning system for extracting features performs feature extraction based on multiple deconvolutions of the sensor data. According to an example embodiment, the method comprises:
performing a deconvolution of the sensor data into tensors, wherein a plurality of tensors of different dimensions is created in parallel processing for at least one measurement point of the sensor data in order to obtain multiple sensor data tensors;
performing at least one preprocessing convolution on each sensor data tensor to obtain preprocessing tensors;
performing a reconvolution of each preprocessing tensor back to the original dimension of the sensor data to obtain reconvolution sensor data;
component-wise summation of the reconvolution sensor data from parallel processing to obtain a joint representation;
applying a localization head to the joint representation to obtain a localization tensor;
deriving a feature position tensor for extracted features based on the localization tensor.

Sensor data are, in particular, data that are perceived by a sensor, for example a camera or another type of sensor. The sensor data can take various forms, in particular image data, depth maps, or other sensor measurements. Sensor data can originate in particular from a physical sensor and/or a synthetic sensor. A synthetic sensor refers in particular to a computer-based process and/or a model that generates data that replicate a sensor signal, but without direct physical measurement. Examples of synthetic sensors include simulations, generative models, and data augmentation techniques.

A feature is, in particular, a characteristic, measurable attribute or property of the sensor data that is relevant for describing an object or phenomenon. In this case, a feature can be reliably detected, in particular across multiple measurement points that comprise overlapping measurements of data.

A measurement point refers in particular to a single, distinguishable unit within a data set. For example, in a data set of image data, a single image represents a measurement point.

Feature extraction is, in particular, a process in which characteristic features are extracted from the sensor data. These features represent in particular relevant information from the sensor data, such as edges, corners, or texture features. Advantageously, the features are represented as vectors or tensors.

A machine learning system for extracting features is, in particular, a system that uses machine learning to learn from data and solve tasks, such as feature extraction from sensor data. Such a system can comprise one or more neural networks.

Deconvolution in the sense of the method according to the present disclosure is in particular an operation in which an input tensor, in particular a two-dimensional tensor, is disassembled into an output tensor of higher dimension, in particular a three-dimensional tensor. In this case, the input tensor is, for example, divided into blocks of a dimension [1, C, C], the components of which, with a dimension [1, 1, 1], are arranged in the output tensor into C·C channels. In particular, a sequence of the components in a channel is defined. For example, an input tensor of the dimension [1, H, W] is disassembled into an output tensor

$$[ C \cdot C , \frac{H}{C} , \frac{W}{C} ] .$$

For reconvolution, the corresponding inverse operation is applied in particular so that, for example, a tensor of a dimension [1, H, W] is obtained again.

In the present disclosure described here, for at least one measurement point, the sensor data are deconvoluted, in particular in parallel processing, into a plurality of sensor data tensors by means of multiple deconvolutions, wherein in particular a different dimension of the blocks is used for each deconvolution. This has the advantage in particular that the sensor data tensors represent the sensor data at different levels of detail, thus allowing features of different granularity to be extracted.

The sensor data tensors are each processed in particular by at least one preprocessing convolution to obtain preprocessing tensors. The preprocessing convolution is, in particular, a convolution in the mathematical sense, the dimension of which is adapted to the sensor data tensors.

The preprocessing tensors are transformed back to an original dimension of the sensor data, in particular by reconvolution, in order to obtain reconvolution sensor data.

The reconvolution sensor data from the parallel processing are summed component-wise in particular to obtain a joint representation. The joint representation includes in particular the original dimension of the sensor data, for example [1, H, W]. Advantageously, components of the joint representation can correspond to a mean value of the respective components of the reconvolution sensor data, therefore avoiding in particular a possible number overflow in a computer implementation.

A localization head is applied to the joint representation. The localization head is a part of the machine learning system for extracting features that operates on the joint representation to generate a localization tensor, wherein the localization head in particular consists of one or more neural networks.

The localization tensor is a tensor that contains localizations of extracted features, wherein the localizations can in particular be relative to a plurality of reference coordinate systems.

Based on the localization tensor, a feature position tensor is derived which in particular specifies positions of the extracted features relative to a common coordinate system with respect to the measurement point of the sensor data.

Advantageous developments and improvements of the method disclosed herein are made possible by the configurations disclosed herein.

It is advantageous if a plurality of preprocessing convolutions is performed on each sensor data tensor, wherein the preprocessing convolutions are applied in multiple layers, wherein a layer comprises at least one preprocessing convolution applied to a result of the preceding layer in each case, and wherein the layers in particular comprise an upsampling and/or downsampling of the deconvolution sensor data.

In an advantageous example embodiment, a plurality of preprocessing convolutions is performed on each sensor data tensor in parallel processing. In this case, the preprocessing convolutions are applied successively in a plurality of layers, wherein a result from one layer is used as the input for a subsequent layer, in particular a directly subsequent layer. By applying a plurality of preprocessing convolutions in multiple layers, different aspects of feature extraction can be mapped and optimized separately; in particular, different levels of detail can be taken into account. Advantageously, the layers can comprise upsampling and/or downsampling, wherein a dimension of the preprocessing convolutions modifies a dimension of the result of the layer. Upsampling and/or downsampling can, for example, save on computing and/or storage resources and/or balance them in parallel processing.

In an advantageous example embodiment, the preprocessing convolutions comprise 1×1 convolutions, in particular with depths equal to the depths of an input processed by the 1×1 convolutions.

1×1 convolutions are convolutions of a dimension [T,1,1], wherein T corresponds to a depth of the convolution, and the convolution has a kernel of dimension 1×1. The depth corresponds in particular to the number of channels of the input of the 1×1 convolution. The 1×1 convolution is applied in particular to all components and their input channels. For example, a 1×1 convolution of dimension [C·C,1,1] can be applied

$$\frac{H}{C} \cdot \frac{W}{C}$$

times to a tensor

$$[ C \cdot C , \frac{H}{C} , \frac{W}{C} ]$$

to obtain a tensor of dimension

$$[ 1 , \frac{H}{C} , \frac{W}{C} ] .$$

By m applications, in particular of various 1×1 convolutions, it is possible to produce an output with m channels, for example

$$[ m , \frac{H}{C} , \frac{W}{C} ] .$$

A number m of applied 1×1 convolutions can be used in particular for upsampling or downsampling. Because the 1×1 convolutions can be performed independently of one another on the input, parallel computation can be particularly advantageous.

It is advantageous if the localization head comprises applying a localization convolution layer to the joint representation to determine the localization tensor.

A localization convolution layer is, in particular, an application of multiple localization convolutions of dimension [1,k,k], which are applied to the joint representation, for example with an increment g. Advantageously, zero padding is added around the joint representation, so that boundary values from the localization convolutions can also be processed in a defined way. A limit of the zero padding can be defined, for example, by

$$p = \frac{k}{2} - \frac{g}{2} .$$

Applying s localization convolutions on the joint representation yields, in particular, the localization tensor with dimension

$$[ s , \frac{H}{g} , \frac{W}{g} ] .$$

In an advantageous example embodiment, the localization tensor is structured based on a grid comprising grid cells, wherein each grid cell corresponds to a region in the joint representation, wherein the localization convolution layer determines one feature position per grid cell, wherein the feature position is determined in particular with subpixel accuracy.

A grid for the localization tensor can be defined in particular by the increment g of the localization convolutions on the joint representation. A grid cell has the dimension [1,g,g] and

$$\frac{H}{g} \cdot \frac{W}{g}$$

grid cells result. For each grid cell, by applying s localization convolutions, a localization [s,1,1] is determined, in particular relative to the center of the grid cell. Advantageously, an absolute feature position can be determined by adding an offset of the center of the grid cell relative to the entire joint representation. Advantageously, the calculation is performed in parallel in order to obtain the feature position tensor of a dimension

$$[ s , \frac{H}{g} , \frac{W}{g} ] .$$

The calculation of the feature position can be dimension determined in particular with floating-point precision. By using floating-point precision, the feature position can be precisely specified and further processed.

It is advantageous to apply additional processing convolutions, in particular 3×3 convolutions, to the joint representation before applying the localization head.

In a preferred example embodiment, the joint representation is processed with additional processing convolutions, for example 3×3 convolutions, before the application of the localization head. By applying processing convolutions, a receptive field of the localization head can be expanded; furthermore, processing convolutions can be used to improve the signal-to-noise ratio. This results, for example, in increased accuracy and robustness of the feature position.

In an advantageous example embodiment, parameters of the machine learning system are learned in a training process.

Parameters of the machine learning system include, in particular, components of the preprocessing convolutions, of the localization head, and components of other applied convolutions. The parameters of the machine learning system are optimized in a training process. This process typically comprises transferring training data to the system with appropriate labels for contained features, extracting the features, calculating an error of the extracted features to the labels, and adjusting the parameters to minimize the error. Suitable training methods comprise, for example, the gradient descent method.

In a preferred example embodiment, the sensor data are image data, wherein the image data in particular originate from a camera system in a robot, wherein the robot is in particular an autonomous vehicle.

Image data are, in particular, digital representations of images which are represented, for example, as two-dimensional arrays of pixels. Each pixel contains, in particular, color or intensity information. A camera system comprises one or more cameras that capture image data, as well as associated hardware and software for controlling, calibrating, and processing the image data.

A robot refers in particular to an autonomous and/or remotely controlled system with sensors and actuators that is used to interact with its environment. Examples of robots include in particular industrial robots, service robots, and autonomous vehicles. Autonomous vehicles are, in particular, land, air and/or water vehicles that can move independently in their environment. Autonomous vehicles use image data, in particular to perceive objects, lane markings, and other environmental information. Extracting features from image data is therefore in particular a basis for various autonomous functions.

In an advantageous example embodiment, the method uses a second machine learning system to determine a descriptor tensor of the extracted features, wherein the second machine learning system can, in particular, be implemented independently of the machine learning system for extracting features.

A descriptor tensor contains, for each feature of the feature position tensor, a descriptor that describes an environment around the feature. The descriptor tensor can be determined in particular by a second machine learning system, which can be implemented independently of the machine learning system for extracting features. Therefore, the second machine learning system can be replaced in particular without adapting the machine learning system for extracting features.

In another example embodiment, the feature position tensor and the descriptor tensor are used to match the extracted features between at least two measurement points of sensor data in order to obtain matching features.

A matching of at least two measurement points of sensor data is used in particular to identify extracted features of one measurement point in another measurement point and thus, in particular, to obtain matching features. The matching is carried out in particular by comparing components of a first descriptor tensor of a first measurement point with at least one second descriptor tensor of a second measurement point. The comparison can be made, for example, using the nearest neighbor classification. For example, a component of the first descriptor tensor is compared to all components of the second descriptor tensor, and a nearest neighbor is determined. The comparison can also be advantageously carried out in the other direction. In another embodiment, the comparison can also be carried out by a machine learning system that has been trained for this purpose. The matching features are defined by components of the first and second descriptor tensors as well as the associated component of a feature position tensor of the first and second measurement points. The matching features can be used in further processing steps, in particular to determine the movements of a sensor relative to its environment.

In another example embodiment, the matching features are key points.

The matching features exhibit high robustness and recognizability and, in an advantageous embodiment, serve as key points for further processing stages. Key points are characterized in that they can be reliably identified even under altered conditions (for example, noise, transformations, changed environmental conditions). For an embodiment in which the sensor data are image data, key points are in particular corners, edges and/or texture features.

In an advantageous example embodiment, the key points are used to determine an optical flow of the image data, wherein the optical flow is used to estimate a position of objects, wherein the position of objects is used in particular to control a longitudinal movement of the robot.

In an advantageous example embodiment, the identified key points are used to determine an optical flow of the image data. Optical flow describes a movement of matching features, in particular key points, between successive images. The optical flow is used to estimate the positions of objects (for example, pedestrians, other vehicles and/or other obstacles). The positions are used in particular to control the longitudinal movement of the robot. This may comprise, in particular, adaptive cruise control and/or automatic emergency braking.

Exemplary embodiments of the present disclosure are explained in more detail below with reference to the figures.

### BRIEF DESCRIPTION OF THE DRAWINGS

FIG. 1 is a schematic representation of an example embodiment of a learning system for extracting features.

FIG. 2 is a schematic representation of an exemplary embodiment with a second machine learning system.

FIG. 3 is a schematic representation of an exemplary embodiment with two measurement points.

### DETAILED DESCRIPTION OF EXAMPLE EMBODIMENTS

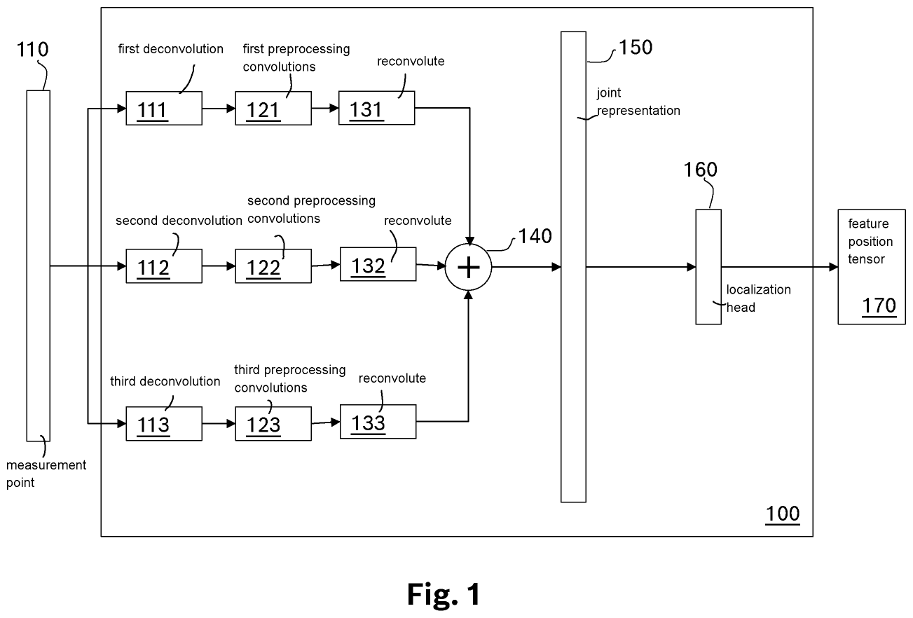

FIG. 1 shows, as an example, a schematic representation of an embodiment of a machine learning system for extracting features (100). In this process, a measurement point (110) of sensor data, which is in particular an image of dimension [1,H,W], is processed by the machine learning system for extracting features (100). The measurement point (110) is deconvoluted, for example, in three parallel processing operations. In this process, a first deconvolution (111) has 16·16=256 channels, as a result of which a first sensor data tensor of dimension

$$[ 256 , \frac{H}{16} , \frac{W}{16} ]$$

is obtained. A second deconvolution (112) has 8·8=64 channels, as a result of which a second sensor data tensor of dimension

$$[ 64 , \frac{H}{8} , \frac{W}{8} ]$$

is obtained. A third deconvolution (113) has 4·4=16 channels, as a result of which a sensor data tensor of dimension

$$[ 16 , \frac{H}{4} , \frac{W}{4} ]$$

is obtained. The first sensor data tensor is then processed by a plurality of first preprocessing convolutions (121) to obtain a first preprocessing tensor of dimension

$$[ 256 , \frac{H}{16} , \frac{W}{16} ] .$$

The first preprocessing convolutions can be, in particular, 1×1 convolutions. Analogously, a plurality of second preprocessing convolutions (122) are performed on the second sensor data tensor to obtain a second preprocessing tensor of dimension

$$[ 64 , \frac{H}{8} , \frac{W}{8} ] .$$

Analogously, a plurality of third preprocessing convolutions (123) are performed on the third sensor data tensor to obtain a third preprocessing tensor of dimension

$$[ 16 , \frac{H}{4} , \frac{W}{4} ] .$$

The first, second, and third preprocessing tensors are now each reconvoluted (131, 132, 133) to a dimension of the sensor data [1,H,W] to obtain reconvolution sensor data. The reconvolution sensor data are then summed (140) component-wise to obtain a joint representation (150) of a dimension [1,H,W]. In component-wise summation, it is also in particular possible to calculate a mean value of the respective components, for example to prevent number overflows.

The joint representation (150) can then optionally be processed by processing convolutions, for example 3×3 convolutions. The joint representation (150) is then processed by a localization head (160). The localization head (160) may in particular comprise an application of a localization convolution layer, wherein the localization convolution layer comprises in particular s=2 k×k localization convolutions with k=8. The convolutions are applied with an increment g=4 across the joint representation (150). Advantageously, zero padding is added around the joint representation, so that boundary values from the localization convolutions can also be processed in a defined way. A limit of the zero padding can be defined, for example, by p=2. The increment g=4 yields a grid with grid cells of dimension [1,4,4] and results in a total of

$$\frac{H}{4} \cdot \frac{W}{4}$$

grid cells on the joint representation. The localization head determines a localization for each of the grid cells, which localizations are combined in a localization tensor for all grid cells. By taking into account a position of the grid cells, a feature position tensor (170) can be derived from the localization tensor. The s=2 localization convolutions are applied sequentially, each resulting in a channel of the localization tensor.

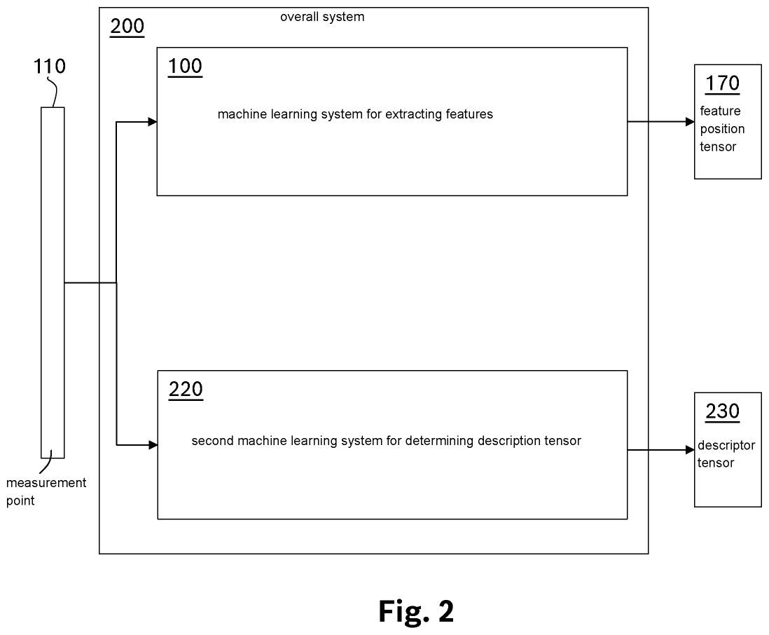

FIG. 2 is a schematic representation of an exemplary embodiment with a second machine learning system. The measurement point (110) of the sensor data is processed by an overall system (200) to obtain the feature position tensor (170) and a descriptor tensor (230). The overall system comprises at least two independent machine learning systems, the machine learning system for extracting features (100) and a second machine learning system for determining the descriptor tensor (220). The second machine learning system for determining the descriptor tensor (220) can be implemented independently of the machine learning system for extracting features (100). This allows any suitable architecture, for example from the XFeat architecture, to be chosen for the second machine learning system for determining the descriptor tensor (220).

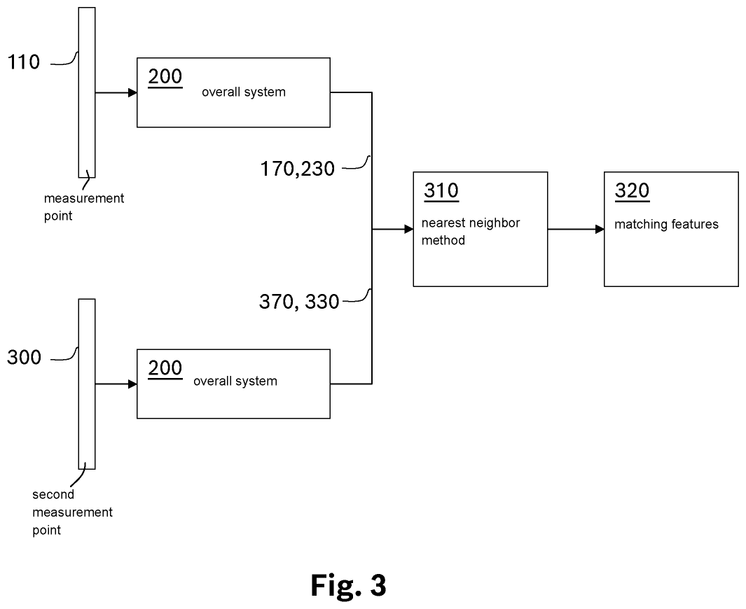

FIG. 3 is a schematic representation of an exemplary embodiment with two measurement points. The measurement point (110) of the sensor data is processed here by the overall system (200) to obtain the feature position tensor (170) and the descriptor tensor (230). In addition, a second measurement point (300) of the sensor data is processed by the overall system (200) to obtain a second feature position tensor (370) and a second descriptor tensor (330). The descriptor tensor (230) and the second descriptor tensor (330) are then compared using the nearest neighbor method (310) to find nearest neighbors in the other tensor in each case. This results in matching features (320). Based on the matching features, further processing can be carried out, such as calculating an optical flow for controlling a robot.

1-15. (canceled)

16. A computer-implemented method for extracting features from sensor data, using a machine learning system for extracting features, wherein the machine learning system for extracting features performs feature extraction based on multiple deconvolutions of the sensor data, the method comprising the following steps:
performing a deconvolution of the sensor data into tensors, wherein a plurality of tensors of different dimensions is created in a parallel processing for at least one measurement point of the sensor data to obtain multiple sensor data tensors;
performing at least one preprocessing convolution on each of the multiple sensor data tensors to obtain preprocessing tensors;
performing a reconvolution of each of the preprocessing tensors back to an original dimension of the sensor data to obtain reconvolution sensor data;
component-wise summation of the reconvolution sensor data from the parallel processing to obtain a joint representation;
applying a localization head to the joint representation to obtain a localization tensor; and
deriving a feature position tensor for extracted features based on the localization tensor.

17. The method according to claim 16, wherein a plurality of preprocessing convolutions is performed on each sensor data tensor, wherein the preprocessing convolutions are applied in multiple layers, wherein each layer of a plurality of the multiple layers includes at least one preprocessing convolution applied to a result of a preceding layer of the layer, wherein the multiple layers include an upsampling and/or downsampling of the sensor data tensors.

18. The method according to claim 16, wherein the preprocessing convolutions include 1×1 convolutions, with depths equal to depths of an input processed by the 1×1 convolutions.

19. The method according to claim 16, wherein the localization head includes applying a localization convolution layer to the joint representation to determine the localization tensor.

20. The method according to claim 19, wherein the localization tensor is based on a grid including grid cells, wherein each grid cell of the grid cells corresponds to a region in the joint representation, wherein the localization convolution layer determines a feature position for each grid cell, wherein the feature position is determined with floating-point precision.

21. The method according to claim 16, wherein additional processing convolutions including 3×3 convolutions are applied to the joint representation before the localization head is applied.

22. The method according to claim 16, wherein parameters of the machine learning system are learned in a training process.

23. The method according to claim 16, wherein the sensor data are image data, wherein the image data originate from a camera system in a robot, wherein the robot is an autonomous vehicle.

24. The method according to claim 16, wherein the method uses a second machine learning system to determine a descriptor tensor of the extracted features, wherein the second machine learning system can be executed independently of the machine learning system for extracting features.

25. The method according to claim 24, wherein the feature position tensor and the descriptor tensor are used to match the extracted features between at least two measurement points of sensor data to obtain matching features.

26. The method according to claim 25, wherein the matching extracted features are key points.

27. The method according to claim 26, wherein the key points are used to determine an optical flow of the image data, wherein the optical flow is used to estimate a position of objects, wherein the position of objects is used to control a longitudinal movement of the robot.

28. A device which is configured to extract features from sensor data, using a machine learning system for extracting features, wherein the machine learning system for extracting features performs feature extraction based on multiple deconvolutions of the sensor data, the device configured to perform the following steps:
performing a deconvolution of the sensor data into tensors, wherein a plurality of tensors of different dimensions is created in a parallel processing for at least one measurement point of the sensor data to obtain multiple sensor data tensors;
performing at least one preprocessing convolution on each of the multiple sensor data tensors to obtain preprocessing tensors;
performing a reconvolution of each of the preprocessing tensors back to an original dimension of the sensor data to obtain reconvolution sensor data;
component-wise summation of the reconvolution sensor data from the parallel processing to obtain a joint representation;
applying a localization head to the joint representation to obtain a localization tensor; and
deriving a feature position tensor for extracted features based on the localization tensor.

29. A non-transitory machine-readable storage medium on which is stored a computer program for extracting features from sensor data, using a machine learning system for extracting features, wherein the machine learning system for extracting features performs feature extraction based on multiple deconvolutions of the sensor data, the computer program, when executed by at least one computer, causing the at least one computer to perform the following steps comprising:
performing a deconvolution of the sensor data into tensors, wherein a plurality of tensors of different dimensions is created in a parallel processing for at least one measurement point of the sensor data to obtain multiple sensor data tensors;
performing at least one preprocessing convolution on each of the multiple sensor data tensors to obtain preprocessing tensors;
performing a reconvolution of each of the preprocessing tensors back to an original dimension of the sensor data to obtain reconvolution sensor data;
component-wise summation of the reconvolution sensor data from the parallel processing to obtain a joint representation;
applying a localization head to the joint representation to obtain a localization tensor; and
deriving a feature position tensor for extracted features based on the localization tensor.
